(19) United States
(12) Patent Application Publication
(10) Pub. No.: US 2011/0218967 A1
(43) Pub. Date: Sep. 8, 2011

(54) Partial Block Based Backups

(75) Inventors: Michael Sliger, Sammamish, WA (US); Anuj Bindal, Bellevue, WA (US); Guhan Suriyanarayanan, Redmond, WA (US); Bodhi Deb, Kirkland, WA (US); James M. Lyon, Redmond, WA (US)

(73) Assignee: Microsoft Corporation, Redmond, WA (US)

(21) Appl. No.: 12/719,837

(22) Filed: Mar. 8, 2010

(51) Int. Cl. G06F 17/00; G06F 11/00; G06F 11/14; G06F 12/00; G06F 12/16

(52) U.S. Cl. 707/647; 714/15; 711/162; 707/E17.01; 714/E11.121; 711/E12.001; 711/E12.103

(57) ABSTRACT

A block based backup system may perform several partial backups to incrementally transfer backup information to a backup system. Each partial backup may build on the previous backup and the partial backups may be marked as unable to be used for restoration. In some cases, the partial backups may be portions of a file system snapshot, while in other cases, the partial backups may include any changes that occurred since a last partial backup. The size of the partial backups may be dynamically changed depending on network connections, workloads, and other factors.

### BACKGROUND

Backup operations are often time consuming. Backup operations for large or even moderately sized systems may take several hours to accomplish. Many backup systems perform a backup operation as an atomic operation, where a backup operation is not committed to storage until the entire backup operation has completed. If an interruption such as a network failure, computer restart, or other event causes the backup operation to fail, the backup operation will restart from the beginning, often causing many hours of work to be abandoned.

### SUMMARY

A block based backup system may perform several partial backups to incrementally transfer backup information to a backup system. Each partial backup may build on the previous backup and the partial backups may be marked as unable to be used for restoration. In some cases, the partial backups may be portions of a file system snapshot, while in other cases, the partial backups may include any changes that occurred since a last partial backup. The size of the partial backups may be dynamically changed depending on network connections, workloads, and other factors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a network environment in which a backup system may operate.

FIG. 2 is a flowchart illustration of an embodiment showing a method for performing a backup operation with one or more partial backup operations.

FIG. 3 is a flowchart illustration of an embodiment showing a method for identifying blocks of data to back up.

FIG. 4 is a flowchart illustration of an embodiment showing a method for preforming a partial backup.

### DETAILED DESCRIPTION

A block based backup system may perform a file system backup operation through several partial backup operations. Each partial backup operation may identify a subset of blocks of data to backup. The subset may be a portion of the entire set of blocks of data that may be backed up to create a copy of an original file system. After the partial backup operations are completed, they can be grouped together into a single backup that can be used to restore a file system.

A backup operation may begin by identifying the blocks of data within a storage device to backup. The blocks of data may be gathered from a master file table or other list of files. A partial backup operation may be performed by identifying a subset of the total set of blocks to backup, then backing up the subset. When the subset has completed backing up, a partial backup may be stored on a backup storage system.

The partial backup may be considered a completed backup, but because the partial backup does not contain all of the blocks to recreate the file system, the partial backup may be considered unusable for a restore operation. The partial backup may be used to indicate which blocks are backed up when a subsequent partial backup is performed. The partial backups may be successively performed until the entire file system has been backed up. When the final partial backup has successfully completed, the backup may be considered usable to restore the file system.

The backup system may operate on a snapshot of the file system. A snapshot may be a version of the file system as the file system was at a specific point of time. Some operating systems may have a function that allows a snapshot to be taken of an operating system so that backup operations, for example, may process the file system at a given state of time. While the backup operation processes the snapshot, the operating system may allow other processes to update and change the file system.

The backup system may perform iterative partial backups on the file system. In such an embodiment, the backup system may perform a partial backup on the file system, and a second partial backup may include blocks of data that have been changed since the previous backup operation. In such an embodiment, the final backup may include a later version of the file system than if the backup system were to back up a snapshot of the file system.

Some embodiments may change the size of the partial backup based on network performance, previous partial backup performance, network connections, or other factors. In such embodiments, the partial backups may be larger or smaller from one partial backup to the next.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, or otherwise processed in a suitable manner and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

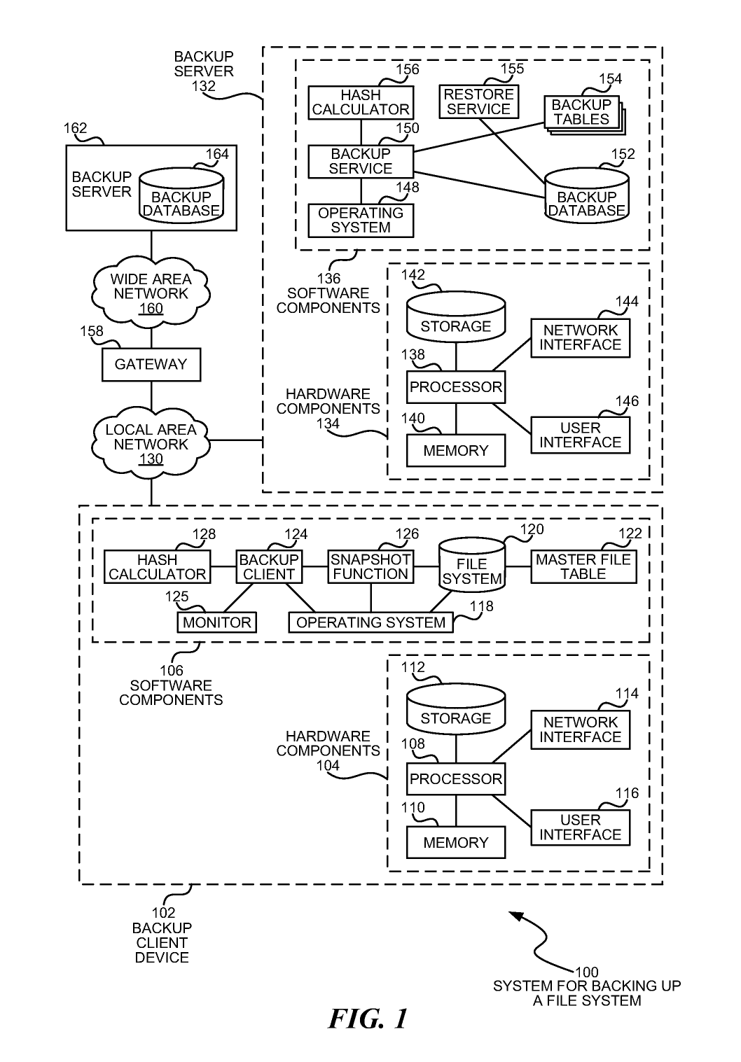

FIG. 1 is a diagram of an embodiment 100, showing a system for backing up a file system. Embodiment 100 is an example of a backup system that uses a client and server architecture. The client may be the device which has a file system to back up, and the server may store the backed up data.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is one example of an architecture by which a file system may be backed up using a partial backup method. The partial backup method may back up portions or subsets of the blocks of data represented by the file system. Each partial backup may be stored on a backup storage device and used to build a final backup when all of the partial backup operations have completed.

The backup system may backup blocks of data from a storage device that contains the file system. A block of data may be a predefined segment of storage space. In many embodiments, the block of data may be the smallest unit of storage used by a storage device. For example, an operating system may store data in 4 KB blocks on a hard disk or other storage device. Each file in the file system may have one or more 4 KB blocks associated with the file. In some embodiments, a block of data may be a larger unit of storage than the minimum size segment addressable by the operating system. Other embodiments may have larger or smaller blocks of data.

The backup system may be a block based backup system. As such, the backup system may backup and restore a file system by respectively copying and restoring individual blocks of data on a physical storage based on the block's placement or location on the original storage device. A file system may be recreated by replacing each block of data in the same physical location on a storage system. This method differs from other backup technologies may use a file based backup, where individual files may be backed up and restored on a file-by-file basis rather than a block-by-block basis.

A block based backup system may be agnostic to the contents of the blocks of data. A usable file system may be recreated when all of the blocks of data are present and placed in their original locations, but the backup system may not organize the blocks of data according to the file system.

A block based backup system may use backup tables to identify how to recreate each backed up version of a file system. A backup table may contain a listing of each position within the original storage device and the identifier of each block of data stored in the position. By maintaining multiple backup tables and using a common database of backed up blocks of data, many versions or instances of a backed up file system may be maintained in a relatively small database. This is because many versions of a file system may contain a large amount of duplicate data.

The file system may be used to identify blocks of data to backup. Once the blocks of data are identified, the blocks may be backed up without regard to the files associated with the blocks.

The backup system may perform backups in several different manners. In one use, the backup system may backup the complete contents of a file system. For example, the backup system may backup a file system where there is no existing backup copy of the file system. In such an example, all of the data within the file system may be copied to a backup storage system and organized so that the original file system may be restored.

Many embodiments may allow a user or administrator to select files to include or exclude from a backup operation. For example, some backup systems may allow a user to exclude temporary files or to select only certain file types or portions of a file directory to backup.

The backup system may perform a backup operation in an incremental manner. An incremental backup may compare a previous backup to determine which files have changed since the last backup. The changed files may be analyzed to identify blocks of data that may have been changed. In some cases, the blocks may not have been changed. For example, a large file may be made up of many blocks of data. The file system may indicate that the file has changed but the change may be limited to a small number of blocks of data. The block based backup system may mark all of the blocks as ‘suspect changed’, and then analyze which blocks are not already backed up. Those blocks that are not already backed up may be copied to the backup storage system.

The backup system may perform partial backups as a process for achieving a full backup. The backup system may select a subset of blocks to backup, and perform a partial backup operation using the subset. If the partial backup fails for some reason, the partial backup may be re-tried.

Backup operations are often performed as an atomic transaction, where the transaction may be committed once all of the data are properly transferred and the backup operation is complete. During a backup operation, large amounts of processing and data transfer may occur, and often larger backups may take several hours to process. If an outside factor would cause the process to fail prematurely, the entire backup operation may be restarted from the beginning.

A partial backup may be useful in situations where a network connection may be broken or other factors may cause a backup operation to fail. A partial backup operation allows a full backup operation to be broken into smaller segments so that in the event of a failure, only a small amount of time may be lost.

An example of such a situation may be a mobile device that may connect and disconnect to a network as a user travels. For example, a user may be connected to a home network, but may disconnect and move to a coffee shop and reestablish a connection. A backup operation may be operating when the device is connected to the network. A portion of the backup may be performed while the device is connected to the home network and other portions performed while connected at the coffee shop. Each partial backup may add to the data already backed up so that when the final partial backup is complete, the system may have a complete backup.

The partial backup may be determined by a threshold. The threshold may be defined in a number of blocks, quantity of data in the blocks, or some other measurement of the size of a partial backup. The threshold may be used to limit the amount of data performed during a partial backup operation.

The threshold may be changed based on various factors. Some embodiments may change the threshold based on the success or failure of a previous partial backup operation. For example, a partial backup operation that fails may cause the threshold to be changed to a lower value so that the next partial backup may contain a smaller number of blocks of data and may have a higher chance to succeed. Conversely, if a partial backup operation is performed quickly and reliably, the threshold may be increased so that the next partial backup may include a larger number of blocks of data.

A smaller threshold may create smaller partial backup operations which would generally result in a longer backup operation, since each partial backup operation has some associated overhead. A larger threshold may create larger partial backup operations, but a failure during the larger backup operations may cause a larger amount of data to be re-transmitted in a subsequent backup operation.

In some embodiments, the threshold may be determined by other factors, such as network location, network performance, device performance, and other factors. In the example above of a device connected to a home network or to a coffee shop network, a large threshold may be used when connected to the home network as the connection may be considered reliable and fast. A smaller threshold may be used in the coffee shop because the connection may be slower and the user may be much more likely to shut down the connection.

The threshold may be determined by performance parameters for the network. The network latency, burst throughput, continuous throughput, or other factors may be used to characterize a network connection and select or calculate a threshold.

The device performance may indicate an appropriate threshold. In situations where the client device hosting the file system is not being used for other processes, the threshold may be larger and the processing power of the device may be devoted to accomplishing the backup operation. When the processor, memory, storage, or network connections are being consumed by other processes, the threshold may be set to a lower value.

The threshold may be set so that each partial backup may consume approximately the same amount of time. In cases where the client device is busy, the threshold may be less than when the client device is unattended and otherwise unused. Such a threshold may be determined by a process that may monitor the status of the device to calculate or estimate an appropriate sized partial backup. In some instances, partial backups may be sized so that each one may take 5 minutes, 10 minutes, 15 minutes, 30 minutes, or possibly an hour or more.

A backup client device 102 is illustrated in embodiment 100. The backup client device 102 may be a device that contains a file system that may be backed up onto a backup storage device. In the architecture of embodiment 100, the backup storage device is illustrated as being located on a server device, either as a backup server 132 attached to a local area network 130 or as a backup server 162 available through a wide area network 160, which may be the Internet.

Other embodiments may include a backup storage device that is attached to the client device 102. For example, a detachable storage device, such as a hard disk, solid state, or other storage device that may be attached using Universal Serial Bus (USB) may be used as the backup storage device. In some cases, a backup storage device may be a tape drive, optical disk, or other storage mechanism that may be permanently or temporarily attached to the client device 102 and for which storage media may be permanently or removably attached.

The backup client device 102 is illustrated as having hardware components 104 and software components 106. The illustration may represent a conventional computer system, but the backup client device 102 may be any device that may have a file system, regardless if the file system is exposed to a user or not.

The backup client device 102 may be a desktop computer, laptop computer, netbook computer, server computer, or other similar device. In some cases, the backup client device 102 may be a portable cellular telephone, a personal digital assistant, a game console, network appliance, or any other computing device.

The hardware components 104 may include a processor 108 that is connected to random access memory 110 and a nonvolatile storage device 112. The hardware components 104 may also include a network interface 114 and a user interface 116.

The software components 106 may include an operating system 118 that may maintain a file system 120. In many embodiments, the file system 120 may be a hierarchical file system that may contain different types of files. The hierarchical file system may arrange files into folders or directories, and there may be many different files within each folder or directory.

In many file systems, a master file table 122 may be used to track and maintain files within the file system. A master file table 122 may contain an entry for each file stored in the file system. The entries may include various metadata about the files, such as file name, creation date, access permissions, file size in blocks, among other items. The master file table 122 may include an address for the starting block of the file as well as the total number of blocks used by the file. Different operating systems may have different mechanisms for storing the data in a master file table 122, and may use other terminology or architectures for accomplishing similar functions.

The backup client 124 may be a software function or application that performs some or all of the backup operations. In some cases, the backup client 124 may operate in conjunction with a backup server application to perform a backup.

The backup client 124 may perform a backup of the file system 120 by identifying blocks of data stored on the storage device 112 and transmitting a subset of the blocks of data to a backup storage device as a partial backup. The process of performing partial backups may repeat until all of the blocks of data are transmitted to the backup storage device and saved as a complete backup. The complete backup may be used to re-create the file system at a later time.

In some embodiments, the backup client 124 may use a snapshot function 126 to perform a backup operation on a file system 120. The snapshot function 126 may take an image of the file system 120 at a designated point in time, then allow the backup client 124 to perform backup operations using the snapshot version of the file system 120. Such an embodiment may allow a backup operation to be completed using a version of the file system at a known point in time, while allowing other applications to modify the file system during the backup operation.

Some embodiments may use a hash calculator 128 to determine if a block of data is stored on the backup storage device. The hash calculator 128 may calculate a hash value for a block of data and the backup client 124 may compare the hash value for the block with the hash values for blocks stored on the backup storage device. If the hash value is not found, the block may be transferred to the backup storage device. If the hash value is found, the block may not be transferred. In both cases, the block may be added to a backup table for the particular backup instance.

The determination of whether a block of data is already stored on a backup storage system may be made by either a client or server device. A client device 102 may make the determination when a table of hash values is transmitted from a server device to the client. In other embodiments, the hash value may be transmitted to the server device and the server device may perform a similar lookup operation on a table of hash values. Such a transmission may be performed as a query in some embodiments.

Some embodiments may not perform a hash calculation and may transmit all of the blocks of data for a backup operation without checking to see if the block of data is already present. Such embodiments may transmit all of the suspect changed blocks to the backup server, regardless if the block of data is already stored in the backup storage device.

The backup client device 102 may have a monitor 125 that may be used to determine a threshold for determining an appropriate size of a partial backup. The monitor 125 may operate in an active or passive mode. In an active mode, the monitor 125 may perform a test of a network connection, processing capabilities, or other factor to determine an appropriate threshold. In some cases, the monitor 125 may detect the network connection, Internet Protocol (IP) address, or other indicators to determine a physical location for the device 102, which may be used to determine an appropriate threshold based on predetermined policies, for example. In a passive mode, the monitor 125 may measure ongoing operations of the device 102 or may capture a history of operations to determine an appropriate threshold.

The architecture of embodiment 100 has a client device 102 attached to a local area network 130, which may include a backup server 132. The backup server 132 may contain hardware components 134 and software components 136, and may operate in conjunction with the client device 102 to perform backup operations.

In some embodiments, a backup operation may involve considerable handshaking and interaction between the client device 102 and the server 132. Other embodiments may involve fewer interactions. Some embodiments may involve large amounts of processing for calculating hash values and performing lookups on hash tables, while other embodiments may not.

The backup server 132 may have hardware components 134 in a similar manner as the client device 102. The hardware components 134 may include a processor 138 that may connect to random access memory 140 and nonvolatile storage 142. The hardware components 134 may also include a network interface 144 and a user interface 146.

The nonvolatile storage 142 may be a system that stores the backup database 152, backup tables 154, and other software components 136 that may be used to store and recreate a file system. In some embodiments, the nonvolatile storage 142 may be a system that has multiple storage devices, such as multiple hard disk drives or other storage media. In some cases, multiple hard disk drives may be configured in a RAID array.

The software components 136 may include an operating system 148 on which a backup service 150 may execute. The backup service 150 may receive and store blocks of data in a backup database 152 and may create backup tables 154 by which a restore service 155 may recreate a file system.

A hash calculator 156 calculate hash values for the blocks of data stored in the backup database 152 and may generate and maintain a table of hash values that may be used to determine if a block of data may be already stored in the backup database 152.

In some embodiments, the functions of the backup server 132 may be accessed across a local area network 130, through a gateway 158, and across a wide area network 160 to a remote backup server 162. The remote backup server 162 may have a backup database 164. In some such embodiments, the remote backup server 162 may be a remote server or service that performs the same operations as described for the local backup server 132. Some such embodiments may be a cloud service.

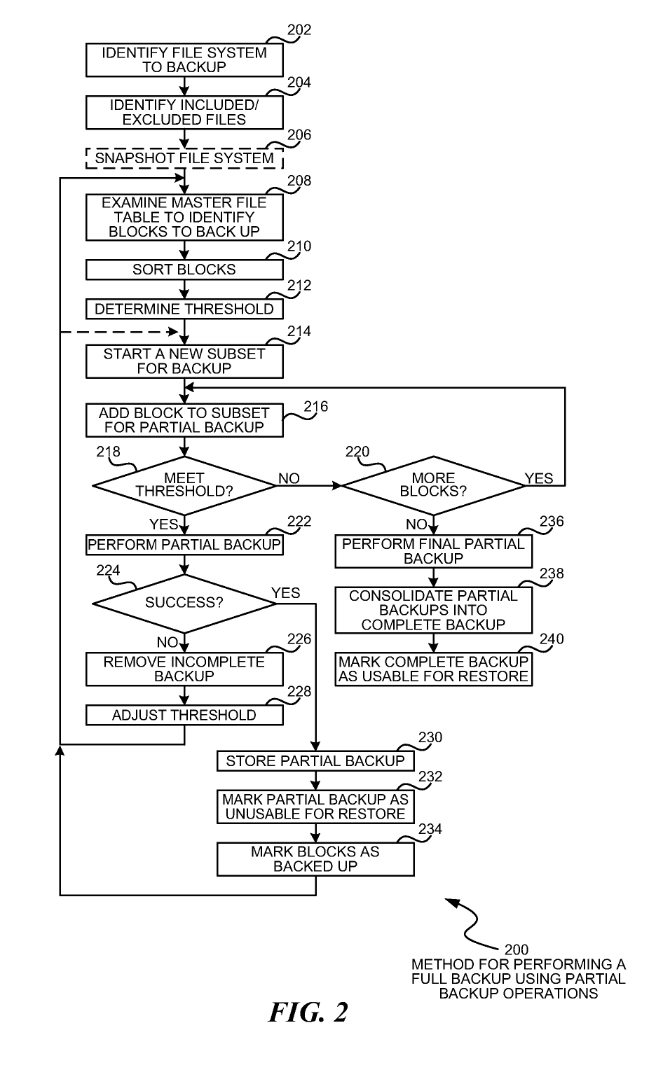

FIG. 2 is a flowchart illustration of an embodiment 200 showing a method for performing a full backup operation using partial backup operations. Embodiment 200 is an example of some of the operations that may be performed by a backup client application operating on a backup client device, such as the backup client 124 operating on the backup client device 102.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is an example method by which a full backup may be performed in stages or using partial backup operations. Embodiment 200 may illustrate a method that uses a snapshot to perform a backup on a file system from a certain period of time. Embodiment 200 may also illustrate another version where partial backup operations may be successively performed on a file system without a snapshot. In such a version, the partial backup operations may include newly updated files that may have been updated after a previous partial backup operation has completed.

The file system to backup may be identified in block 202. In many cases, the file system may be an entire file system stored on a particular storage device or system. In some cases, the file system identified in block 202 may be defined by a certain volume or logical subset of a storage device, or may be a logical storage system that may span multiple storage devices.

In block 204, included and excluded files may be identified. Some embodiments may permit a user or administrator to select what is backed up by selecting specific files, specific types of files, portions of a file system, or other mechanism to identify which files are to be backed up and which files are to be ignored.

A snapshot of the file system may be taken in block 206. In embodiments where the snapshot is used, the subsequent partial backup operations may operate to successively backup the snapshot image.

The master file table may be examined in block 208 to determine which blocks of data are to be backed up. An example of the process performed by block 208 is illustrated later in this specification as embodiment 300, although other embodiments may use different methods. The result of block 208 may be a list of blocks that are marked for backup. Specifically, the blocks identified in block 208 may be suspect changed blocks.

In some embodiments, the operations of block 208 may be to categorize all of the blocks in the file system as either empty, already backed up, or suspect changed. The empty blocks may be blocks for which no file is associated and can be skipped by the backup system. The blocks marked already backed up may indicate blocks of data that are known to be stored in the backup storage device. The blocks marked suspect changed may be blocks that are possibly changed. In some cases, the blocks marked suspect changed may in fact be already backed up, as would be the case if a previously backed up large file with multiple blocks was modified in a small way affecting only one or two blocks.

The blocks may be sorted in block 210. In many cases, a file may be stored in blocks that are physically separated from each other and are not contiguous. Such fragmented files may have blocks of data that are spread out across a hard disk drive or other storage system.

The sorting in block 210 may place all of the suspect blocks for backup in order of their physical position on the file system's storage device. Such an order may speed up block transfers by reducing seek times during the transfer operation.

A threshold may be determined in block 212. The threshold may be determined by a default setting in some embodiments. Some embodiments may employ active testing to determine network connectivity, throughput, processing bandwidth, or other factors to determine an appropriate threshold setting. In some embodiments, the threshold setting may be a previously used setting that is stored and updated from time to time.

A new subset of blocks may be started in block 214. The subset may contain those blocks that are going to be attempted to be backed up in a partial backup operation.

A block may be added to the subset in block 216. In embodiments where the blocks are sorted, the block added may be the next block in the sequence of sorted blocks.

If the addition of the block from block 216 does not exceed the threshold in block 218 and there are more blocks in block 220, the process may return to block 216 to gather another block. The process may continue adding blocks until either the threshold is met in block 218 or there are no more blocks in block 220.

When the threshold is met in block 218, a partial backup may be performed in block 222. An example of a backup operation may be illustrated in embodiment 400 presented later in this specification.

If the partial backup is not successful in block 224, the incomplete partial backup may be discarded in block 226 and the threshold may be adjusted in block 228. The threshold adjustment of block 228 may adjust the threshold down so that a smaller partial backup is performed for the next partial backup.

If the process of embodiment 200 is being performed on a snapshot representation of the file system, the process may return to block 214 to create a new partial backup with an updated threshold setting.

If the process of embodiment 200 is being performed without a snapshot, the process may return to block 208. By returning to block 208, the process may re-analyze the master file table to determine an updated set of blocks to backup. The updated set may include any changes made to the file system while the previous partial backup operation may have been performed.

If the partial backup operation was a success in block 224, the partial backup may be stored in block 230 on the backup storage device.

The partial backup may be marked as unusable for restoring in block 232. Because the backup system is a block based backup system, an incomplete backup of block 230 may be unusable for restoring a file system as the backup system may not be able to identify each block associated with each file. A block based backup system may be able to recreate a file system by placing all of the blocks of the file system in their proper order and placement, and such an operation can be completed when the entire set of blocks has been successfully backed up.

The blocks that were successfully backed up in block 230 may be marked as backed up in block 234. Once the successful partial backup has completed, the process may return to either block 208 or 214, depending on whether or not a snapshot was used.

When no more blocks are available in block 220, the partial backup being performed may be the last backup. The final partial backup may be performed in block 236. The final partial backup may be consolidated with the partial backups on block 238 to create a single, complete backup, which may be marked as being usable for restoration in block 240.

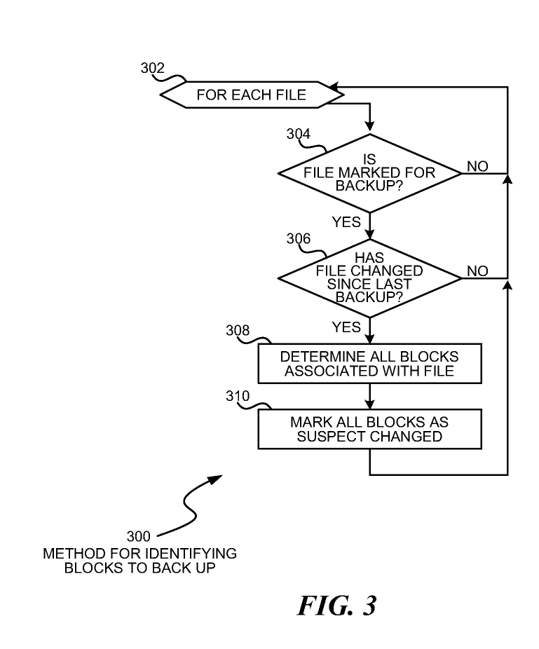

FIG. 3 is a flowchart illustration of an embodiment 300 showing a method for identifying blocks of data to backup. Embodiment 300 is an example of the operations that may be performed for block 208 of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Each file of a master file table may be processed in block 302.

If the file is not marked for backing up in block 304, the file may be skipped and the process may return to block 302.

If the file is marked for backing up in block 304 but has not changed since the last backup operation in block 306, the file may be skipped and the process may return to block 306. Such an embodiment may perform a backup operation as an incremental backup. In order to determine if a file has already been backed up, the client device may have a date stamp from a previous backup and may compare the creation or modification date stamp for the file with the date stamp from the previous backup.

If the file has changed in block 306, all of the blocks associated with the file may be identified in block 308 and the blocks may be marked as suspect changed in block 310. The process may return block 302 to process another file.

After all of the files have been processed, the process of embodiment 300 may end.

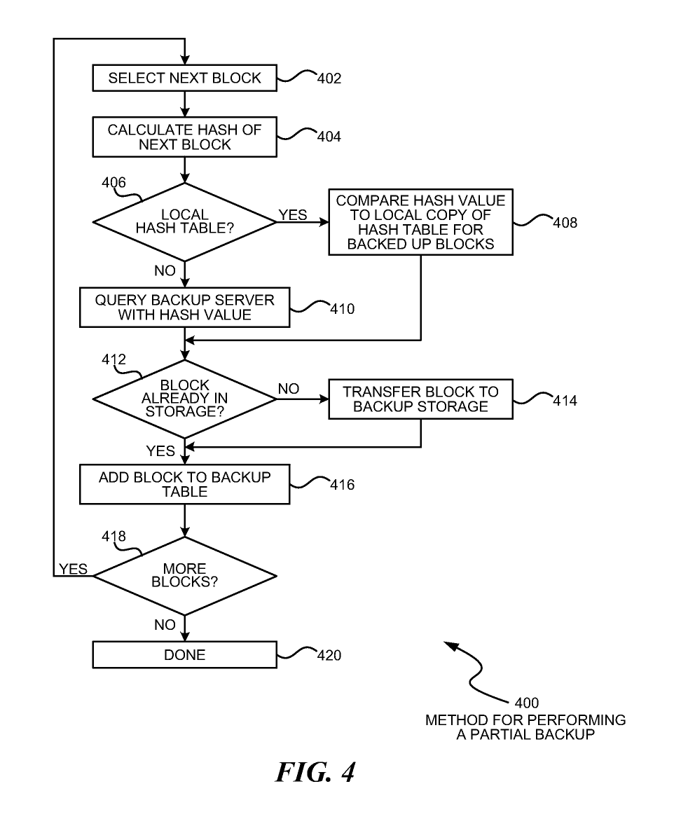

FIG. 4 is a flowchart illustration of an embodiment 400 showing a method for performing a partial backup. Embodiment 400 is an example of a process that may be performed for blocks 222 or 236 of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates a method for performing a partial backup by using a hash value to determine if a block is already stored on a backup storage device.

A block of data is selected in block 402, and a hash value is calculated from the block in block 404.

If the process uses a local hash table in block 406, the calculated hash value can be compared to the local copy of the hash table in block 408. The local hash table may contain the hash values for all of the blocks of data stored in the backup storage device.

If the process does not use a local hash table in block 406, the process may perform a query over the network to a backup server in block 410 to determine if the hash value is found in the hash table residing on the backup server.

If the block is not in the backup storage device in block 412, the block may be transferred to the backup storage device in block 414.

Once the block of data is in the storage device, either by being transferred in block 414 or by having already been stored in the backup storage device in block 416, the block may be added to the backup table in block 416. The backup table may contain a listing of the blocks of data and their physical positions within the storage device for the file system. The backup table may be used by a restoration system to recreate the file system on the same or another storage device.

If more blocks are present for processing in block 418, the process may return to block 402. When all of the blocks of data are processed in block 418, the process may end in block 420.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method of backing up a file system to a backup storage system, said file system being stored on a storage system as a plurality of blocks of data, said method comprising:
analyzing said file system to identify a set of said blocks of data to backup;
performing one or more partial backups by selecting a subset of said blocks of data to perform a partial backup, backing up each of said subset of blocks of data to create a partial backup on said backup storage system, said partial backup being unusable for restore operations;
performing a final partial backup by selecting remaining blocks of data that have not been backed up by said one or more partial backups, backing up said remaining blocks of data, and creating a final backup comprising said one or more partial backup, said final backup being usable for restore operations.

2. The method of claim 1 further comprising:
sorting said blocks of data into a sorted list; and
selecting said subset in order of said sorted list to create said subset.

3. The method of claim 2, said sorting being in order of block placement on said storage system.

4. The method of claim 1, said analyzing said file system comprising:
identifying a file that has not been backed up;
identifying one or more blocks of data associated with said file; and
adding said one or more blocks of data to said set of said blocks of data.

5. The method of claim 1, said backing up comprising:
determining that a first block is currently stored by said backup storage system and not transferring said first block to said storage system; and
determining that a second block is not stored by said backup storage system and transferring said second block to said storage system.

6. The method of claim 5, said determining being performed by:
calculating hash values for each said first block and said second block and querying said backup storage system to determine that said first block is present in said backup storage system and said second block is not present in said backup storage system.

7. The method of claim 1 further comprising:
attempting to perform a first partial backup and detecting a failure of said first partial backup; and
retrying said first partial backup until said first partial backup is successful and proceeding to a next partial backup.

8. The method of claim 1, said subset being selected by using a threshold to determine a limit for said subset.

9. The method of claim 8, said threshold being defined as a maximum size of data to transfer.

10. The method of claim 8 further comprising:
attempting to perform a first partial backup and detecting a failure of said first partial backup;
changing said threshold based on said failure to create a modified threshold; and
retrying said first partial backup using said modified threshold.

11. The method of claim 10 further comprising:
classifying a network connection to said backup storage system to determine said threshold.

12. The method of claim 11, said classifying comprising determining a bandwidth for said network connection.

13. The method of claim 11, said classifying comprising determining a reliability for said network connection.

14. The method of claim 1, said analyzing said file system comprising marking each of said blocks of data as one of a group composed of empty, backed up, and suspect.

15. The method of claim 14, after completing said partial backup, marking each of said subset of blocks of data as backed up.

16. A system comprising:
a connection to a backup storage system;
a file storage system comprising a file system comprising a plurality of files, each of said files being stored in at least one blocks of data on said file storage system;
a processor that performs a method comprising:
analyzing said file system to identify a set of said blocks of data to backup;
determining a threshold for a partial backup;
performing one or more partial backups by selecting a subset of said blocks of data to perform a partial backup, said subset being determined using said threshold, backing up each of said subset of blocks of data to create a partial backup on said backup storage system, said partial backup being unusable for restore operations;
performing a final partial backup by selecting remaining blocks of data that have not been backed up by said one or more partial backups, backing up said remaining blocks of data, and creating a final backup comprising said one or more partial backup, said final backup being usable for restore operations.

17. The system of claim 16 further comprising:
a threshold management system that determines a performance parameter for said connection and sets said threshold based on said performance parameter.

18. The system of claim 17, said threshold management system determining said performance parameter using an active method to determine said performance parameter.

19. A method of backing up a file system to a backup storage system, said file system being stored on a storage system as a plurality of blocks of data, said method comprising:
analyzing said file system to identify a set of said blocks of data to backup, said analyzing comprising comparing blocks of data contained in said storage system to blocks of data stored on said backup storage system to identify a first set of blocks of data that are not stored on said backup storage system and are contained in said storage system;
performing one or more partial backups by selecting a subset of said first set of blocks of data to perform a partial backup, backing up each of said subset of blocks of data to create a partial backup on said backup storage system, said partial backup being unusable for restore operations;
performing a final partial backup by selecting remaining blocks of data that have not been backed up by said one or more partial backups, backing up said remaining blocks of data, and creating a final backup comprising said one or more partial backup, said final backup being usable for restore operations.

20. The method of claim 19, said first set of blocks of data being identified by performing a process for each of said blocks of data on said storage system, said process comprising:
determining a hash for said block of data;
comparing said hash to a table of hashes stored on said backup storage system; and
determining that said block of data is present on said backup storage system when said hash is found in said table of hashes and determining that said block of data is not present on said backup storage system when said hash is not found in said table of hashes.
